(19) United States
(12) Patent Application Publication
(10) Pub. No.: US 2006/0104078 A1
(43) Pub. Date: May 18, 2006

(54) Cord-type light-emitter

(75) Inventors: Chi-Tsung Peng, Hsinchu City (TW); Ching-Shan Wang, Hsinchu City (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(73) Assignee: BAYCOM OPTO-ELECTRONICS TECHNOLOGY CO., LTD

(21) Appl. No.: 10/986,844

(22) Filed: Nov. 15, 2004

(51) Int. Cl. G09F 13/00

(52) U.S. Cl. 362/554; 362/551; 362/208; 362/200; 362/201

(57) ABSTRACT

A cord-type light-emitter is composed of a light source device and a sideward transmitting optical fiber. One end of the optical fiber is formed with a connector for fixing to the light source device. The light source device includes at least a light source and a control circuit board enclosed in a case. The sideward transmitting optical fiber is made of ray-conducting polymer material capable of transmitting light sideward along the fiber. The control circuit board controls the light source illuminating continuously or flashing with a suitable frequency according to user's needs.

### BACKGROUND OF THE INVENTION

1. Field of the Invention

The invention generally relates to a cord-type light-emitter, and in particular relates to a light-emitter capable of emitting light sideward along an optical fiber cord.

2. Description of the Related Art

For people taking activities outdoors in the night, there is usually a need to have some kinds of light-emitters for the safety purpose, especially for those weakly people.

Some traffic officers on duty wear jackets with reflective stripes for their safety. Various reflective materials from conventional reflective tapes to advanced optical fiber reflectors are being used. However, common people do not have reflective jackets for the outdoor use. People walking in dark are easily get collision by car because of the low visibility during low light level conditions. The fast moving vehicle cannot stop right away after seeing the passenger.

Other usual needs of light emitters, lamps or signal lights are when people camping outdoors. Camping helps people relaxing and communication. However, activities in the dark are somehow dangerous. Therefore, illumination or noticing light signals in dark are quite important. Conventional signal lamps, multiple lamps, oil lamps, or battery-powered lamps are limited to their size, installation, or safety problems and cannot be conveniently carried and used.

In view of the aforesaid problems, the invention intends to provide a cord-type light-emitter that is easy to be carried and used for the outdoor safety purposes.

### SUMMARY OF THE INVENTION

The object of the invention is to provide a cord-type light-emitter that is easy to be carried and used for safeguard and noticing purposes.

A cord-type light-emitter according to the invention is composed of a light source device and a sideward transmitting optical fiber. One end of the optical fiber is formed with a connector for fixing itself to the light source device. The light source device includes at least a light source and a control circuit board enclosed in a case.

When using to where an elongated light-emitter is needed, another light source is included on the other end of the optical fiber for enhancing the luminosity. A power cord is provided along the optical fiber for providing electrical power to the light source.

The sideward transmitting optical fiber is made of ray-conducting polymer material mixed with impurities for transmitting the light emitted from the light source along and sideward from the fiber. The control circuit board controls the light source illuminating continuously or flashing with a suitable frequency according to user's needs.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a cord-type light-emitter as a first embodiment of the invention;

FIG. 2 is an exploded view of a cord-type light-emitter of the invention;

FIG. 3 is a compositional view of a cord-type light-emitter of the invention;

FIG. 4 is a cord-type light-emitter as a second embodiment of the invention; and

FIG. 5 is an explanatory example of applications of a cord-type light-emitter of the invention.

### DETAILED DESCRIPTION OF PREFERRED EMBODIMENTS OF THE INVENTION

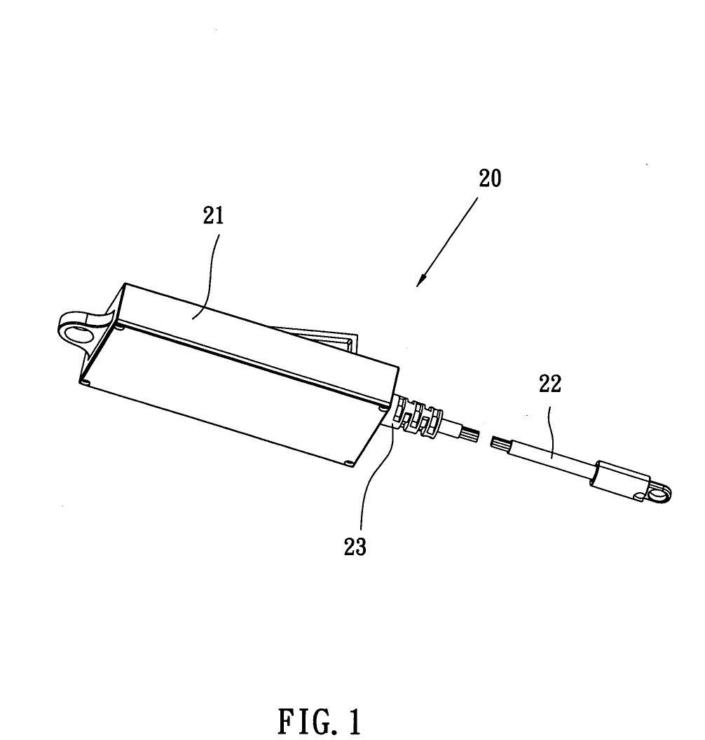

As shown in FIG. 1, a first preferred embodiment of the invention. The cord-type light-emitter 20 mainly includes a light source device 21 and a sideward emitting optical fiber 22. An end of the optical fiber 22 is formed with a connector 23 for fixing to the light source device 21.

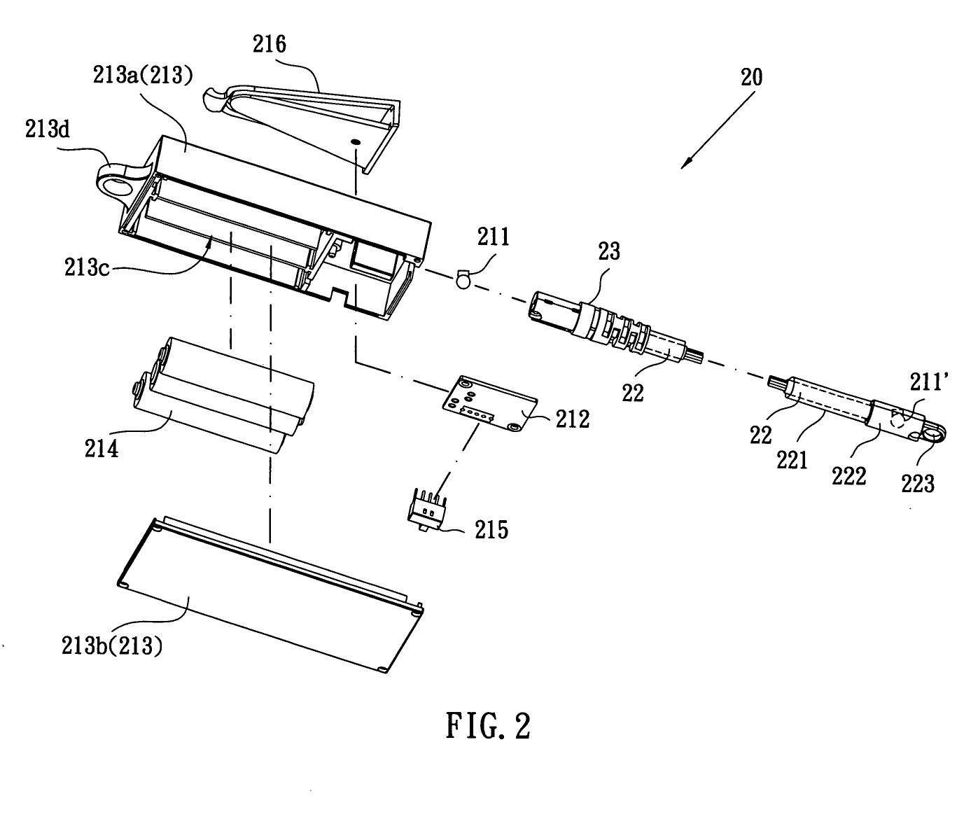

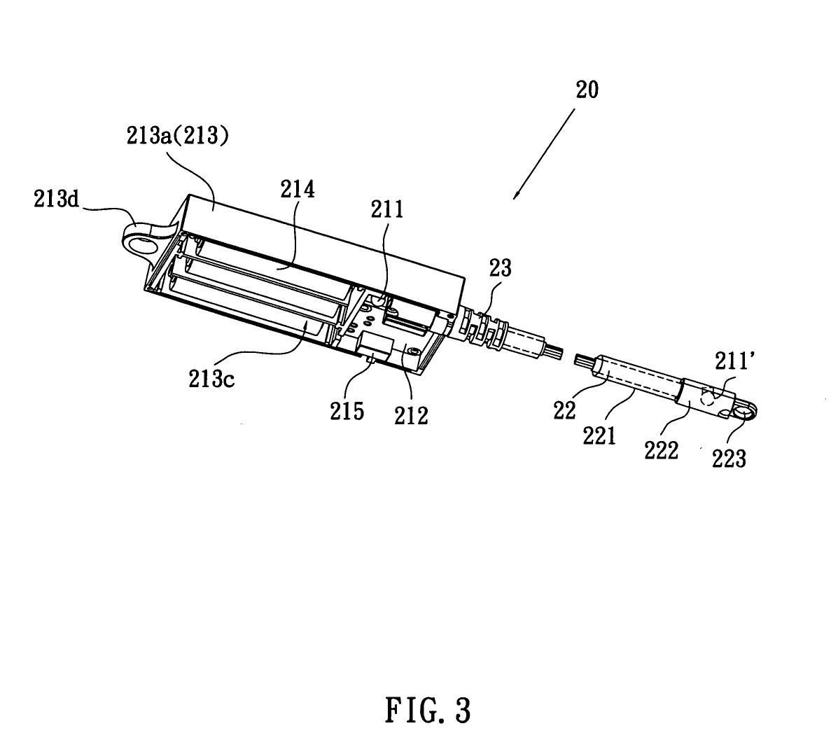

As shown in FIGS. 2 and 3. The light source device 21 of the light-emitter 20 includes a light source 211, a control circuit board 212, and a case 213 composed of a box 213a and a cover 213b. The box 213a is formed with a space 213c for locating the light source 211 and the control circuit board 212. The light source device 21 further includes batteries 214 and a switch 215 to form a circuit loop with the control circuit board 212 for controlling output of the light source 211. The light source 211 thus continuously emits or flashes for noticing according to the application requirements. The batteries 214 in the space 213c provide electrical power to the light source device 21. The batteries 214 include primary batteries or rechargeable batteries such as Carbon-Zinc battery, Mercury battery, Li-ion battery and so on. The switch 215 is located on the box 213a for controlling on/off of the electrical power. The sideward emitting optical fiber 22 of the light-emitter 20 is to conduct the light and achieve the sideward emission. The surface of the optical fiber 22 is further formed with a covering layer 221 for protecting the surface from being damaged and influenced of the light emission. The connector 23 of the sideward emitting optical fiber 22 is fixed to the case 213 and extending into the space 213c. A suitable gap is kept at the end of the connector 23 to the light source 211 so that the light beam is guided via the connector 23 into the optical fiber 22. Another embodiment of arrangement is that the light source 211 is directly mounted inside the connector 23 for providing light beam into the optical fiber 22 and achieve the lighting or noticing function.

Still referring to FIGS. 2 and 3, a hole (or a hook) 213d is formed on a top end of the box 213a for hanging purpose. The shape and dimensions of the hole 213d can be modified according to the hanging requirements. There is also a clamp 216 formed or fixed on side of the box 213a for clamping to objects when hanging is not applicable. For the need of a longer light-emitter, an additional light source 211′ is provided at the end of the optical fiber 22 to enhance the luminosity of the light-emitter from the elongated end of the optical fiber 22. For example, a light source unit 222 for containing the light source 211′ is fixed at the end of the optical fiber 22. A power cord (not shown in the drawing) for providing electrical power from the light source device 21 to the additional light source 211′ is provided along the optical fiber 22. There is also a hole or a hook 223 formed on end of the light source unit 222 for hanging the light-emitter 20 by the end or by both ends including the hole 213d.

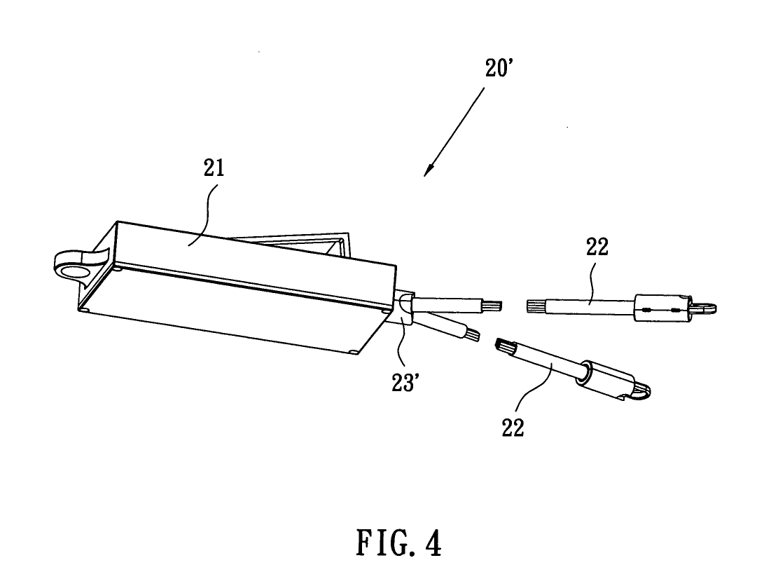

FIG. 4 shows a cord-type light-emitter as a second embodiment of the invention. The light-emitter 20′ is composed of a light source device 21 and two optical fibers 22. The two optical fibers 22 are jointed into a connector 23′ fixed to the light source device 21. The connector 23′ receives two (or more) ends of optical fibers 22 so that two (or more) optical fibers 22 can receive light beams from the light source device 21. The light source 21 in the light source device 22 is powered by batteries and controlled by a control circuit board for the required continuous lighting or flashing.

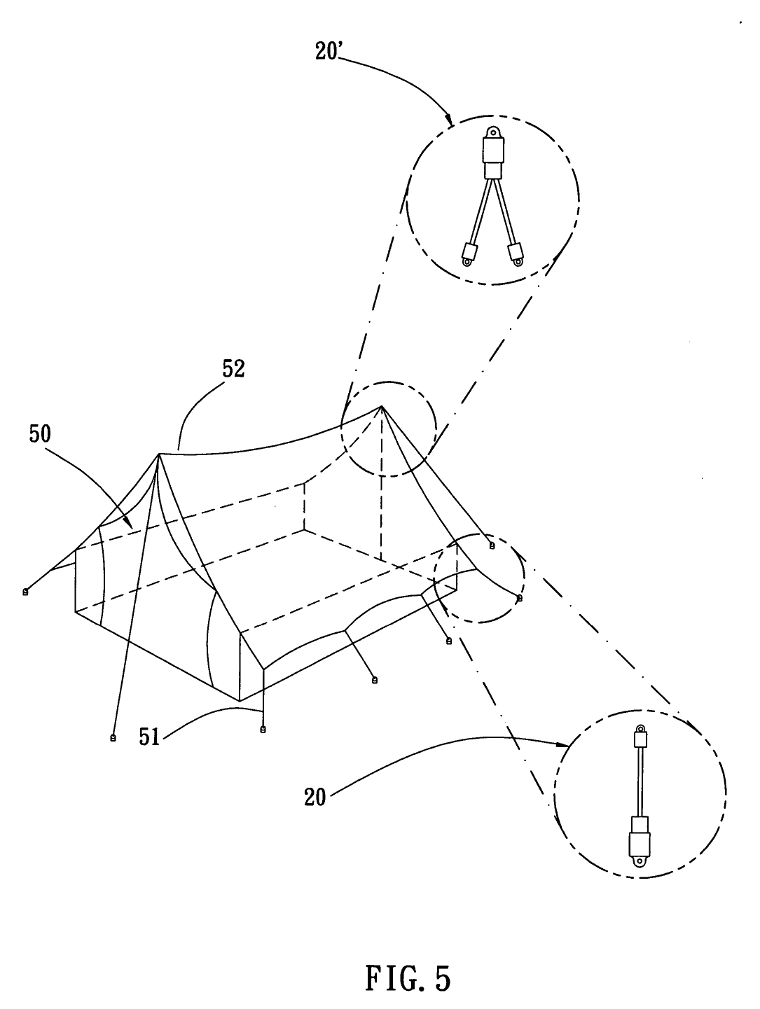

FIG. 5 is an explanatory example of applications of a cord-type light-emitter of the invention. The light-emitter 20 can be installed on a fixing cord 51 of a camp 50 for providing sideward light for illumination. Another example is to mount the light-emitter 20′ on the top 52 of the camp 50 by hanging with the holes or hooks. Of course, the applications of the invention are not limited to the examples.

As described above, the light-emitter 20, 20′ of the invention is applicable to any suitable place for illumination or noticing purpose. It can be mounted, hung or clamped to a fixed or movable object, for example, used on a car, a camp or carried by people to achieve the safeguard function. The cord-type sideward-emitting light-emitter is more convenient than conventional light-emitters.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A cord-type light-emitter, comprising:
a light emitting device composed of a case formed with a space; a light source enclosed in said case and a control circuit board enclosed in said case for controlling said light source; and
at least a sideward-emitting polymer optical fiber, having one end fixed to said case, for conducting light beam from said light emitting device.

2. A cord-type light-emitter according to claim 1 wherein said case is formed with one of a hole and a hook.

3. A cord-type light-emitter according to claim 1 wherein said case is formed with a clamp.

4. A cord-type light-emitter according to claim 1 wherein said polymer optical fiber is covered with a protective layer.

5. A cord-type light-emitter according to claim 1 further comprises a light source formed on another end of said optical fiber.

6. A cord-type light-emitter according to claim 1 wherein said light emitting device comprises batteries and a switch.

7. A cord-type light-emitter according to claim 6 wherein said batteries are enclosed in said case.

8. A cord-type light-emitter according to claim 6 wherein said switch is mounted on said case.

9. A cord-type light-emitter according to claim 6 wherein said batteries include primary batteries or rechargeable batteries.
